(19) United States
(12) Patent Application Publication
(10) Pub. No.: US 2005/0276969 A1
(43) Pub. Date: Dec. 15, 2005

(54) Cushioning material for flexographic printing

(76) Inventors: Takako Ohyama, Komagane-shi (JP); Hiromasa Kawaguchi, Komagane-shi (JP); Hideo Ikoma, Komagane-shi (JP)

Correspondence Address: MCGLEW & TUTTLE, PC, P.O. BOX 9227, SCARBOROUGH STATION, SCARBOROUGH, NY, 10510-9227, US

(21) Appl. No.: 11/109,028

(22) Filed: Apr. 19, 2005

(30) Foreign Application Priority Data
Jun. 11, 2004 (JP) 2004-174118

(51) Int. Cl. C08G 18/00; B32B 3/12; B32B 3/26; B32B 7/12; B32B 15/04; B41F 13/10; B41F 27/06

(52) U.S. Cl. 428/343; 428/304.4; 428/354; 428/160; 521/159

(57) ABSTRACT

To provide a cushioning material for flexographic printing in which an adhesive strength between the cushioning material and an adhesive increases when adhesion processing is performed on the cushioning material, and hence no adhesive remains on an adherend such as a printing cylinder when a printing plate is peeled off from the adherend. The cushioning material for flexographic printing includes a polyurethane foam produced by using a reactive silicone foam stabilizer. The reactive silicone foam stabilizer used for producing the polyurethane foam has an SiO % preferably in the range of 10 to 25%. The polyurethane foam has a density preferably in the range of 0.1 to 0.7 g/cm³ and a bubble fraction of 60% or less.

### BACKGROUND OF THE INVENTION

1. Field of the Invention

The present invention relates to a cushioning material optimum as a cushioning element to be used between a flexographic printing plate and a printing cylinder in flexographic printing.

2. Description of the Related Art

In flexographic printing, a flexographic printing plate is fixed to the body of a printing cylinder, and then printing is performed. Various methods of fixing the flexographic printing plate to the printing cylinder have been conventionally proposed. However, in these days, a pressure sensitive adhesive double coated sheet for fixing a printing plate has often been used because the sheet can be easily handled and allows precise printing. The pressure sensitive adhesive double coated sheet for fixing a printing plate is obtained by forming adhesive layers on both surfaces of a cushioning material having resilience and an elastic force against compression.

FIG. 8 is a partial sectional view showing a conventional example, and shows a state where a flexographic printing plate 19 is fixed to a printing cylinder 18 by means of a pressure sensitive adhesive double coated sheet 11 for fixing a printing plate. The pressure sensitive adhesive double coated sheet 11 for fixing a printing plate is obtained by forming adhesive layers 13 and 14 on both surfaces of a cushioning material 12. The flexographic printing plate 19 is attached to the adhesive layer 13 and the adhesive layer 14 is attached to the printing cylinder 18, whereby the flexographic printing plate 19 is attached to the printing cylinder 18 (see, for example, Flexograhic Printing Directory (issued on Nov. 9, 2000 by Processing technique workshop, p 175)).

Therefore, the printing plate must be peeled off from the printing cylinder after the completion of printing. In addition, when a large number of sheets are subjected to printing, the printing plate is peeled off from the printing cylinder and washed in order to maintain high-quality printing. In each of those cases, the pressure sensitive adhesive double coated tape (sheet) is peeled off from the printing cylinder and the printing plate. At this time, the pressure sensitive adhesive double coated tape (sheet) must be peeled off successfully with no tape (sheet) residue remaining on the printing cylinder and the printing plate.

A thermoplastic resin foam such as polyethylene has been mainly used as the cushioning material 12 used for the pressure sensitive adhesive double coated sheet 11 for fixing a printing plate. A polyurethane foam more excellent in rebound resilience has often been used as well.

A thermoplastic resin foam such as polyethylene has a high bubble fraction. Continued use of the foam reduces distortion properties, and cushioning properties (an elastic force and resilience) cannot be expected. On the other hand, a polyurethane foam maintains good cushioning properties for a long period of time.

However, the polyurethane foam uses a silicone-based foam stabilizer at the time of production, so the silicone bleeds to the urethane surface, which reduces an adhesive strength between the urethane surface and an adhesive when adhesion processing is performed. As a result, there arises a problem in that the adhesive remains on an adherend such as a printing cylinder or a printing plate when the printing plate is peeled off from the printing cylinder. For example, in the case of the pressure sensitive adhesive double coated sheet for fixing a printing plate shown in FIG. 8 obtained by forming the adhesive layers 13 and 14 on both surfaces of a polyurethane foam as the cushioning material 12, there arises a problem in that the cushioning material 12 and the adhesive layer 14 undergo interlayer peeling to allow an adhesive to remain on the printing cylinder 18 when the printing plate 19 is peeled off from the printing cylinder 18, and also requires an extra work to remove the adhesive after the peeling. In addition, when the adhesive remains on the printing cylinder 18 to make the adhesive layer 14 nonuniform, there arises, for example, a problem in that the pressure sensitive adhesive double coated sheet cannot be repeatedly used.

### SUMMARY OF THE INVENTION

The present invention has been proposed in order to solve such problems as described above, and an object of the present invention is to provide a cushioning material for flexographic printing in which when adhesion processing is performed on the cushioning material, an adhesive strength (bonding strength) between the cushioning material and an adhesive increases and hence no adhesive remains on an adherend such as a printing cylinder when a printing plate is peeled off from the adherend.

Another object of the present invention is to provide a cushioning material for flexographic printing which has good thickness accuracy and good printing accuracy, improved distortion properties leading to good distortion, and is capable of maintaining appropriate cushioning properties (an elastic force and resilience) for a long period of time.

The cushioning material for flexographic printing of the present invention is characterized by including a polyurethane foam produced by using a reactive silicone foam stabilizer.

The reactive silicone foam stabilizer, used as a foam stabilizer at the time of producing the polyurethane foam, has a reactive group, so the silicone foam stabilizer does not bleed out to the surface of the polyurethane foam even when a sufficient amount of silicone-based foam stabilizer is added to perform molding, and only a trace amount of silicone is present on the surface of the polyurethane foam. Accordingly, when adhesion processing is performed, an adhesive force between an adhesive and the surface of the polyurethane foam (cushioning material) increases. As a result, when the polyurethane foam (cushioning material) is peeled off from an adherend, the adhesive is not peeled off from the cushioning material (polyurethane foam) or the adhesive does not remain on the adherend either.

In addition, the polyurethane foam of the cushioning material for flexographic printing of the present invention is characterized in that it has a density in the range of 0.1 to 0.7 g/cm³.

When the density of the polyurethane foam is set to fall within the range of 0.1 to 0.7 g/cm³, distortion properties are improved and appropriate cushioning properties are maintained for a long period of time. As a result, the cushioning material can be used an increased number of times. A polyurethane foam having a density outside the range is too hard or too soft to provide appropriate cushioning properties for the cushioning material to be used in flexographic printing.

In addition, the polyurethane foam of the cushioning material for flexographic printing of the present invention has a bubble fraction of preferably 60% or less, or particularly preferably 30% or more and 60% or less.

This is because a bubble fraction in excess of 60% reduces distortion properties of the cushioning material, which hinders to reuse the cushioning material. On the other hand, a bubble fraction of less than 30% reduces cushioning properties even though the cushioning material may be reused. A bubble fraction of 30% or more and 60% or less improves distortion properties, and provides appropriate cushioning properties for the cushioning material for a long period of time.

In addition, the reactive silicone foam stabilizer in the polyurethane foam of the cushioning material for flexographic printing of the present invention is characterized in that it has an SiO % in the range of 10 to 25%.

An SiO % of the reactive silicone foam of less than 10% dose not provide a sufficient foam stabilizing force, while an SiO % in excess of 25% causes an unreacted portion to bleed out to the surface of the polyurethane foam to thereby reduce the adhesive force (bonding force) of the surface of thepolyurethane foam. Therefore, the SiO % of the reactive silicone foam is preferably in the range of 10 to 25%.

In addition, the cushioning material for flexographic printing of the present invention is characterized by including: a polyurethane foam, as a substrate, produced by using a reactive silicone foam stabilizer; and an adhesive layer formed on at least one surface of the substrate.

As a result, as described above, the adhesive force between the polyurethane foam (substrate) and the adhesive is strong enough to prevent a situation where the adhesive is peeled off from the cushioning material at the time of removal (peeling) to remain on the adherend, even when a printing plate is attached to a printing cylinder by adhesion using the cushioning material.

In addition, the cushioning material for flexographic printing of the present invention is characterized by including: a polyurethane foam, as a substrate, produced by using a reactive silicone foam stabilizer; and a reinforcing film arranged on one surface of the substrate, the reinforcing film being integrally molded with the substrate or being arranged on the surface via an adhesive layer.

As a result, in addition to the above effects, following effects are obtained: unnecessary stretch of the polyurethane foam (substrate) is prevented because the reinforcing film is arranged; thickness accuracy is improved and printing accuracy becomes good; and the polyurethane foam is not destroyed at the time of peeling, the polyurethane foam is not broken to remain on the flexographic printing plate, and the adhesive does not remain on the flexographic printing plate, because the reinforcing film is interposed between the polyurethane foam and the adhesive layer to which a flexographic printing plate is attached.

Furthermore, the present invention is characterized in that the cushioning material for flexographic printing has a total light transmission of 55% or more.

As a result, the cushioning material becomes transparent or semitransparent. Therefore, a marking for positioning given to, for example, the printing cylinder can be seen through the cushioning material at the time of attachment of a flexographic printing plate to the printing cylinder. Accordingly, the flexographic printing plate can be positioned precisely, and easily attached without the occurrence of misalignment.

In the present invention, the term “reactive silicone foam stabilizer” refers to a foam stabilizer having a reactive group capable of reacting with polyol, isocyanate, or the like that are to be used for producing urethane. Examples of the reactive group of the reactive silicone foam stabilizer include a hydroxyl group, an amino group, an epoxy group, a carboxyl group, a methacryl group, a mercapto group, and a phenol group. Of those, in terms of reactivity with isocyanate, a hydroxyl group, an amino group, and an epoxy group are preferable. In addition, there may be cases where the reactive group is introduced into one terminal of polysiloxane or each terminal thereof, or is introduced into a side chain thereof. Among those cases, the case where the reactive group is introduced to a side chain is preferable for a foam stabilizer for urethane.

The cushioning material for flexographic printing of the present invention provides the following effects.

(1) The silicone foam stabilizer does not bleed out to the surface of the polyurethane foam as a cushioning material, and only a trace amount of silicone is present on the surface of the polyurethane foam. As a result, when adhesion processing is performed, an adhesive force between the polyurethane foam and the adhesive increases.

(2) Since the printing plate is attached to the printing cylinder by using the cushioning material for flexographic printing adopting the polyurethane foam, the adhesive is not peeled off from the polyurethane foam at the time of peeling, and the adhesive does not remain on the adherend.

(3) The polyurethane foam as the cushioning material of the present invention has improved distortion properties, has good distortion, maintains appropriate cushioning properties (an elastic force and resilience) for a long period of time, and hence can be used an increased number of times.

(4) The reinforcing film improves the thickness accuracy and prevents the unnecessary stretch of the polyurethane foam. As a result, the printing accuracy is improved, and printing with improved finished quality can be performed.

(5) Since the marking for positioning given to the printing cylinder can be seen through the cushioning material at the time of attachment of a flexographic printing plate to the printing cylinder, the flexographic printing plate can easily be positioned precisely and attached to a precise position without the occurrence of misalignment.

(6) In general, it has been necessary to increase the adhesiveness (tackiness) of an adhesive used for such a cushioning material as that of the present invention with urethane to be higher than the adhesiveness of the adhesive with a printing plate or a cylinder in order that the adhesive may not be peeled off from a polyurethane foam at the time of peeling, and the adhesive may not remain on the adherend (cylinder), in addition to the improvement of the adhesiveness with the printing plate or the cylinder. The cushioning material of the present invention, however, uses the polyurethane foam produced by using the reactive silicone foam stabilizer, so a high adhesive force is established between urethane and the adhesive even without consideration of the adhesiveness between urethane and the adhesive. As a result, the adhesive neither transfers to the printing plate or to the cylinder, nor remains on the printing plate or the cylinder. In addition, when the reinforcing film is integrally molded with urethane, the reinforcing film is hardly peeled off from urethane.

### BRIEF DESCRIPTION OF THE DRAWINGS

In the accompanying drawings:

FIG. 1 is a front view showing an example of a cushioning material for flexographic printing of the present invention (Example 9);

FIG. 2 is a front view showing another example of a cushioning material for flexographic printing of the present invention (Example 10);

FIG. 3 is a front view showing further another example of a cushioning material for flexographic printing of the present invention (Example 11);

FIG. 4 is a front view showing still another example of a cushioning material for flexographic printing of the present invention (Example 12);

FIG. 5 is a view for explaining how a peel force is measured;

FIG. 6 is a graph obtained by measuring a peel force while an SiO % of a reactive silicone foam is changed;

FIG. 7 is a graph showing results obtained by measuring a 25% compression residual strain while a bubble fraction is changed; and

FIG. 8 is a partially enlarged front view showing a conventional example.

### DETAILED DESCRIPTION OF THE PREFERRED EMBODIMENTS

The cushioning material for flexographic printing of the present invention includes a polyurethane foam produced by using a reactive silicone foam stabilizer. The term “reactive silicone foam stabilizer” refers to a foam stabilizer having a reactive group capable of reacting with polyol, isocyanate, or the like that are to be used for producing urethane. The reactive silicone foam stabilizer, used as a foam stabilizer at the time of production of the polyurethane foam, has a reactive group, so the silicone foam stabilizer does not bleed out to the surface of the polyurethane foam even when a sufficient amount of silicone-based foam stabilizer is added to perform molding, and only a trace amount of silicone is present on the surface of the polyurethane foam. Accordingly, when adhesion processing is performed, an adhesive force between an adhesive and the surface of the polyurethane foam (cushioning material) increases. As a result, even when the polyurethane foam is peeled off from the adherend, the adhesive is not peeled off from the polyurethane foam (cushioning material), and hence the adhesive does not remain on the adherend.

The reactive silicone foam stabilizer has an SiO % preferably in the range of 10 to 25%. An SiO % of less than 10% does not provide an expected foam stabilizing force, while an SiO % in excess of 25% causes an unreacted portion to bleed out to the surface of the polyurethane foam to thereby reduce the adhesive force (bonding force) of the surface of the polyurethane foam.

The polyurethane foam produced by using the reactive silicone foam stabilizer has a density preferably in the range of 0.1 to 0.7 g/cm³. A polyurethane foam having a density outside the range is too hard or too soft to provide appropriate cushioning properties for the cushioning material to be used in flexographic printing. When the density of the polyurethane foam is set to fall within the range of desirably 0.1 to 0.7 g/cm³, or more desirably 0.3 to 0.6 g/cm³, distortion properties are improved, appropriate cushioning properties are maintained for a long period of time, and hence the cushioning material can be used an increased number of times.

In addition, the polyurethane foam has a bubble fraction of preferably 60% or less, or particularly preferably 30% or more and 60% or less. A bubble fraction of less than 30% does not provide optimum cushioning properties even though the cushioning material may be reused. On the other hand, a bubble fraction in excess of 60% reduces distortion properties of the cushioning material, which hinders to reuse the cushioning material. A bubble fraction of 30% or more and 60% or less improves distortion properties, and provides appropriate cushioning properties for the cushioning material for a long period of time.

Hereinafter, the present invention will be described in detail by way of examples.

### EXAMPLE 1

Appropriate amounts of a catalyst for urethane curing and a foaming agent were added to 100 parts of a polyether-based polyol, 0.2 part of a silicone-based foam stabilizer containing a hydroxyl group at its terminal (having an SiO % of 16.2%), andmethylene diphenyl diisocyanate index 106 to produce a polyurethane foam.

### EXAMPLE 2

Appropriate amounts of a catalyst for urethane curing and a foaming agent were added to 100 parts of a polyether-based polyol, 0.5 part of a silicone-based foam stabilizer containing a hydroxyl group at its terminal (having an SiO % of 16.2%), and methylene diphenyl diusocyanate index 106 to produce a polyurethane foam. Example 2 is different from Example 1 in that the amount of the silicone-based foam stabilizer containing a hydroxyl group at its terminal was changed to 0.5 part.

### EXAMPLE 3

Appropriate amounts of a catalyst for urethane curing and a foaming agent were added to 100 parts of a polyether-based polyol, 1.0 part of a silicone-based foam stabilizer containing a hydroxyl group at its terminal (having an SiO % of 16.2%), andmethylene diphenyl diisocyanate index 106 to produce a polyurethane foam. Example 3 is different from Example 1 in that the amount of the silicone-based foam stabilizer containing a hydroxyl group at its terminal was changed to 1.0 part.

### COMPARATIVE EXAMPLE 1

Appropriate amounts of a catalyst for urethane curing and a foaming agent were added to 100 parts of a polyether-based polyol, 0.2 part of a silicone-based foam stabilizer having an unreactive terminal (having an SiO % of 18.7%), and methylene diphenyl diisocyanate index 106 to produce a polyurethane foam. Comparative Example 1 is different from Example 1 in that the foam stabilizer of Example 1 was changed to the silicone-based foam stabilizer having an unreactive terminal.

### COMPARATIVE EXAMPLE 2

A polyurethane foam was produced in the same manner as in Comparative Example 1 except that the amount of the foam stabilizer of Comparative Example 1 was changed to 0.5 part.

### COMPARATIVE EXAMPLE 3

A polyurethane foam was produced in the same manner as in Comparative Example 1 except that the amount of the foam stabilizer of Comparative Example 1 was changed to 1.0 part.

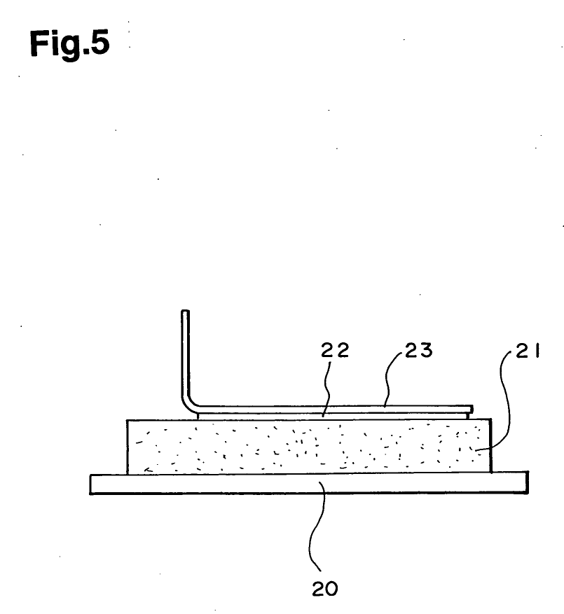

A peel force was measured as described below in order to evaluate an adhesive force between each of the polyurethane foams of Examples 1 to 3 and an adhesive, and an adhesive force between each of the polyurethane foams of Comparative Examples 1 to 3 and the adhesive. As shown in FIG. 5, a polyurethane foam 21 was fixed to a slide plate 20. A PET film 23 to which an adhesive for flexographic printing had been applied to have a thickness of 50 μm was attached to the polyurethane foam 21. Then, a peel force between the PET film 23 and the polyurethane foam 21 was measured in accordance with an adhesive force according to JIS Z0237 90° peeling method. Table 1 shows the measurements.

TABLE 1

| | | | | Comparative | Comparative | Comparative |
|---|---|---|---|---|---|---|
| | Example 1 | Example 2 | Example 3 | Example 1 | Example 2 | Example 3 |
| Reactive foam stabilizer (part) | 0.2 | 0.5 | 1.0 | | | |
| Unreactive foam stabilizer (part) | | | | 0.2 | 0.5 | 1.0 |
| Peel force (N/25 mm) | 17.1 | 20.1 | 20.0 | 4.0 | 4.9 | 2.9 |
| Peeling state | Transfer to | Transfer to | Transfer to | Interface | Interface | Interface |
| | urethane | urethane | urethane | destruction | destruction | destruction |

According to the measurements shown in Table 1, in each of Examples 1 to 3, the adhesive adhered to the polyurethane foam 21 to show that an adhesive force between the adhesive and the foam was strong. On the other hand, in each of Comparative Examples 1 to 3, interface destruction occurred at an interface between the adhesive and the polyurethane foam 21 to show that an adhesive force between the adhesive and the foam was weak. It can be understood from the foregoing that a polyurethane foam obtained by using a reactive silicone foam stabilizer as a foam stabilizer provides a strong adhesive force with an adhesive.

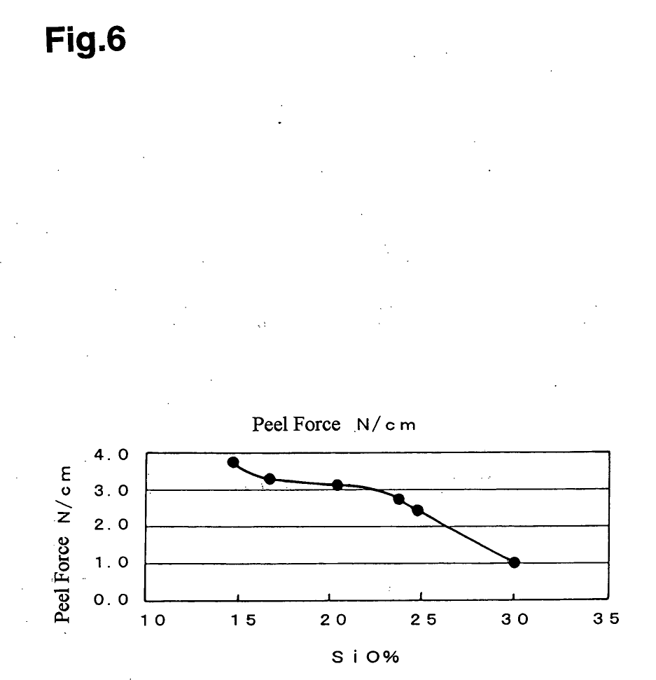

In addition, a peel force was measured while the SiO % of the reactive silicone foam was changed. As a result, a graph shown in FIG. 6 was obtained. It can be understood from the graph shown in FIG. 6 that an SiO % in excess of 25% tends to abruptly reduce the peel force (N/cm) and hence the SiO % is preferably in the range of 10% to 25% in which a foam stabilizing force is exerted.

Next, appropriate amounts of a catalyst for urethane curing and a foaming agent (water) were adjusted to be added to 100 parts of a polyether polyol, 2 parts of a silicone foam stabilizer containing a hydroxyl group at its terminal (having an SiO % of 16.2%), and methylene diphenyl diisocyanate index 106 to produce polyurethane foams different from each other in density and bubble fraction.

### EXAMPLE 4

Of the resultant polyurethane foams, a polyurethane foam having a density (g/cm³) of 0.45 and a bubble fraction (%) of 16 was provided as a polyurethane foam of Example 4.

### EXAMPLE 5

Of the resultant polyurethane foams, a polyurethane foam having a density of 0.45 and a bubble fraction of 31 was provided as a polyurethane foam of Example 5.

### EXAMPLE 6

Of the resultant polyurethane foams, a polyurethane foam having a density of 0.45 and a bubble fraction of 46 was provided as a polyurethane foam of Example 6.

### EXAMPLE 7

Of the resultant polyurethane foams, a polyurethane foam having a density of 0.32 and a bubble fraction of 37 was provided as a polyurethane foam of Example 7.

### EXAMPLE 8

Of the resultant polyurethane foams, a polyurethane foam having a density of 0.58 and a bubble fraction of 59 was provided as a polyurethane foam of Example 8.

### COMPARATIVE EXAMPLE 4

Of the resultant polyurethane foams, a polyurethane foam having a density (g/cm³) of 0.45 and a bubble fraction (%) of 66 was provided as a polyurethane foam of Comparative Example 4.

### COMPARATIVE EXAMPLE 5

Of the resultant polyurethane foams, a polyurethane foam having a density of 0.08 and a bubble fraction of 0 was provided as a polyurethane foam of Comparative Example 5.

Table 2 shows the 25% compression residual strains (%) and returning elastic compressibilities (%) of the polyurethane foams of Examples 4 to 8 and Comparative Examples 4 and 5.

TABLE 2

| | | | | | | | Comparative | Comparative |
|---|---|---|---|---|---|---|---|---|
| | | Example 4 | Example 5 | Example 6 | Example 7 | Example 8 | Example 4 | Example 5 |
| Density | g/cm³ | 0.45 | 0.45 | 0.45 | 0.32 | 0.58 | 0.45 | 0.08 |
| Bubble fraction | % | 16 | 31 | 46 | 37 | 59 | 66 | 0 |
| Returning elastic compressibility | % | 5.4 | 7.1 | 7.9 | 7.0 | 8.4 | 7.8 | 3.2 |
| 25% compression residual strain | % | 5 | 8 | 8 | 9 | 6 | 18 | 10 |

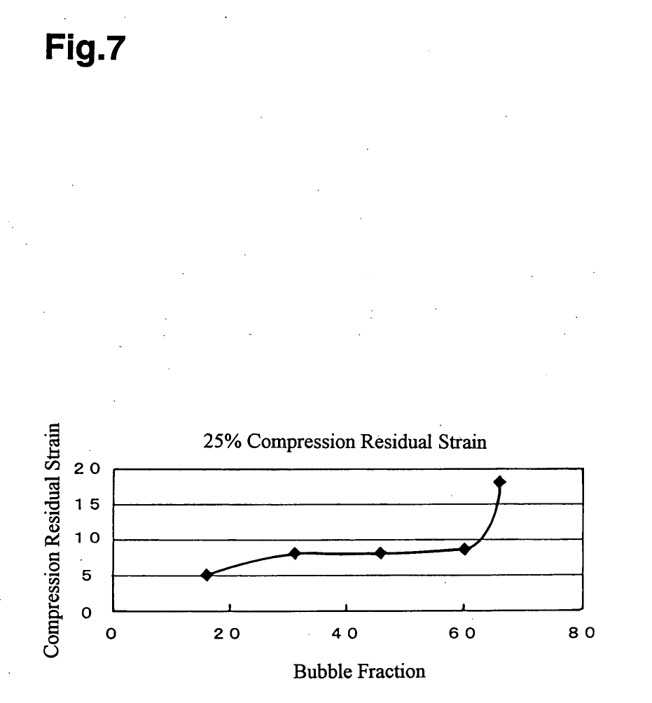

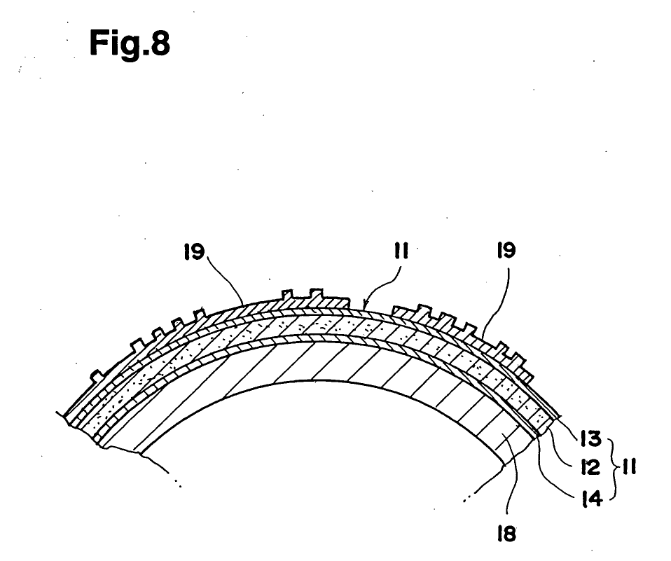

The measurements shown in Table 2 show that a bubble fraction in excess of 60% like Comparative Example 4 deteriorates the 25% compression residual strain (%), and hence the bubble fraction is preferably 60% or less. In addition, it can be understood that a bubble fraction of less than 30% like Example 4 and Comparative Example 5 does not provide appropriate cushioning properties even though the cushioning material may be reused, and hence the bubble fraction is most preferably in the range of 30% or more and 60% or less. FIG. 7 is a graph showing a relationship between the bubble fraction and the 25% compression residual strain in the measurements. It can be understood from FIG. 7 that a bubble fraction in excess of 60% abruptly increases the 25% compression residual strain.

### EXAMPLE 9

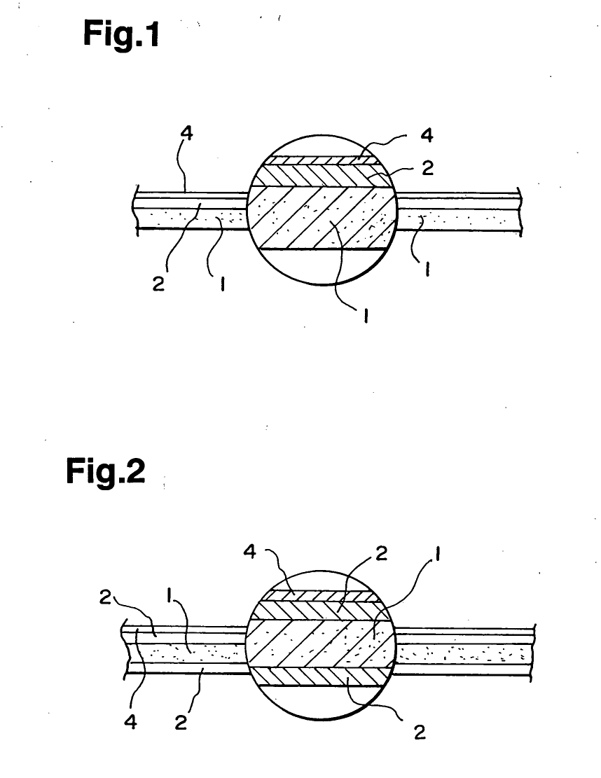

Next, an example of the cushioning material for flexographic printing of the present invention will be described. FIG. 1 is a front view showing the cushioning material for flexographic printing of the present invention. The cushioning material for flexographic printing is formed by: applying an adhesive layer 2 to one surface of a substrate 1 formed by a polyurethane foam produced by using a reactive silicone foam stabilizer; and protecting the adhesive layer 2 with released paper 4. At the time of use of the cushioning material, the released paper 4 is peeled, and the cushioning material is attached to an adherend by means of the adhesive layer 2.

### EXAMPLE 10

FIG. 2 is a front view showing another example of the cushioning material for flexographic printing of the present invention. The cushioning material for flexographic printing is formed by: arranging adhesive layers 2 on both surfaces of a substrate 1 formed by a polyurethane foam produced by using a reactive silicone foam stabilizer; and protecting the adhesive layer 2 on one surface with released paper 4. The released paper 4 may be arranged to protect the adhesive layers 2 on both surfaces. However, the sheet is produced by winding, so the adhesive layers 2 on both surfaces can be protected by arranging the released paper 4 on one surface. Therefore, it is sufficient to arrange the released paper 4 on one surface. Arrangement of the released paper 4 on both surfaces leads to an increase in cost and is uneconomical. At the time of use of the cushioning material, the released paper 4 is peeled, and the cushioning material is attached to a printing plate by means of the adhesive layer 2 on one surface and is attached to a printing cylinder by means of the adhesive layer 2 on the other surface.

### EXAMPLE 11

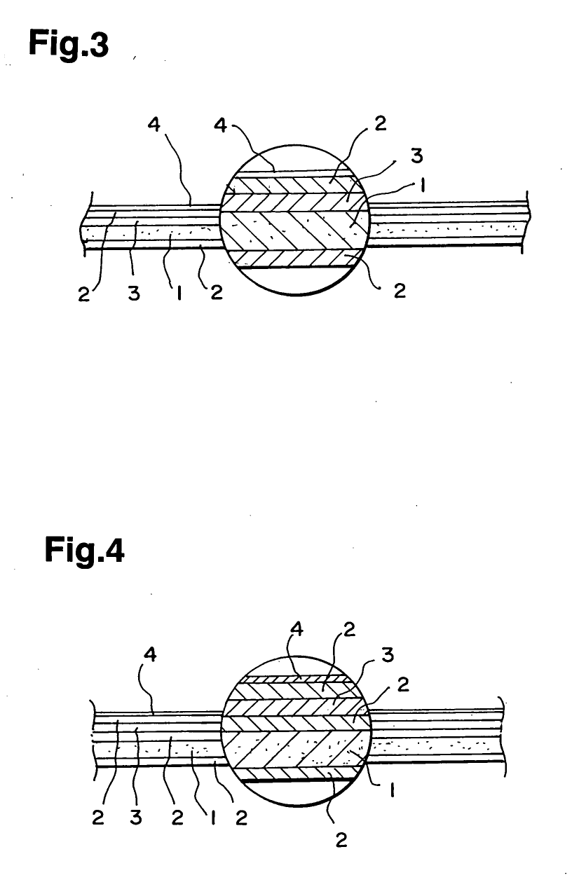

FIG. 3 is a front view showing further another example of the cushioning material for flexographic printing of the present invention. The cushioning material for flexographic printing is formed by: arranging an adhesive layer 2 on one surface of a substrate 1 formed by a polyurethane foam produced by using a reactive silicone foam stabilizer; arranging a reinforcing film 3 on the other surface to be integrally molded with the substrate 1; arranging another adhesive layer 2 on the surface of the reinforcing film 3 other than the surface thereof in contact with the substrate 1; and protecting the other adhesive layer 2 with released paper 4. At the time of use of the cushioning material, the released paper 4 is peeled, and the cushioning material is attached to a printing plate by means of one adhesive layer 2 and is attached to a printing cylinder by means of the other adhesive layer 2. In this example, the cushioning material is provided with the reinforcing film 3, so unnecessary stretch of the cushioning material is prevented and thickness accuracy is improved. An example of the reinforcing film 3 includes a PET film.

### EXAMPLE 12

FIG. 4 is a front view showing still another example of the cushioning material for flexographic printing of the present invention. The cushioning material for flexographic printing is formed by attaching a reinforcing film 3 to a substrate 1 through an adhesive layer 2 between them. The other constitution is the same as that of Example 11. The same reference numerals are given to the same constituents, and detailed description thereof is omitted.

The adhesive force of the adhesive in the cushioning material for flexographic printing described above is preferably in the range of about 1.5 N/cm to 6 N/cm when the thickness of the substrate 1 is about 0.3 to 1 mm, preferably in the range of about 1.5 N/cm to 8 N/cm when the thickness of the substrate 1 is about 2 mm, or preferably in the range of about 1.5 N/cm to 11 N/cm when the thickness of the substrate 1 is about 4 mm. As the polyurethane foam becomes thicker, the repulsive force of urethane increases, so the adhesive force must be higher. An adhesive force below the above range is not enough to sufficiently fix the cushioning material to the printing cylinder or to the printing plate, while an adhesive force above the range requires a considerable force for peeling the printing plate off from the printing cylinder after the completion of printing, and may cause the cushioning material to which a tape (reinforcing film) is attached to break.

The substrate 1, formed by the polyurethane foam produced by using the reactive silicone foam stabilizer, has a reactive group, so the silicone foam stabilizer does not bleed out to the surface of the polyurethane foam even when a sufficient amount of silicone-based foam stabilizer is added to perform molding and only a trace amount of silicone is present on the surface of the polyurethane foam. Accordingly, an adhesive force with the adhesive layer 2 increases. That is, the adhesive force between the polyurethane foam and the adhesive increases as described above. Therefore, if the printing plate is attached to the printing cylinder by using any one of the cushioning materials for flexographic printing shown in Examples 9 to 12, the adhesive is not peeled off from the polyurethane foam (the substrate 1), or the adhesive does not remain on the adherend either, when the cushioning material is peeled off from the adherends (the printing plate and the printing cylinder). In addition, when the density and bubble fraction of the polyurethane foam (the substrate 1) produced by using the reactive silicone foam stabilizer are set to fall within the above ranges, distortion properties are improved, appropriate cushioning properties are maintained for a long period of time, and hence the cushioning material can be used an increased number of times, as described above.

It should be noted that the present invention is not limited to the examples, and various modifications can be made without departing from the gist of the present invention.

1. A cushioning material for flexographic printing, comprising:
a polyurethane foam produced by using a reactive silicone foam stabilizer.

2. A cushioning material for flexographic printing according to claim 1, wherein the polyurethane foam has a density in a range of 0.1 to 0.7 g/cm³.

3. A cushioning material for flexographic printing according to claim 1, wherein the polyurethane foam has a bubble fraction of 60% or less.

4. A cushioning material for flexographic printing according to claim 1, wherein the reactive silicone foam stabilizer in the polyurethane foam has an SiO % in a range of 10 to 25%.

5. A cushioning material for flexographic printing, comprising:
the polyurethane foam as a substrate; and
an adhesive layer formed on at least one surface of the substrate.

6. A cushioning material for flexographic printing, comprising:
a polyurethane foam, as a substrate, produced by using a reactive silicone foam stabilizer; and
a reinforcing film arranged on one surface of the substrate, the reinforcing film being integrally molded with the substrate or being arranged on the surface via an adhesive layer.

7. A cushioning material for flexographic printing according to claim 1, wherein the cushioning material for flexographic printing has a total light transmission 55% or more.

8. A cushioning material for flexographic printing according to claim 2, wherein the polyurethane foam has a bubble fraction of 60% or less.

9. A cushioning material for flexographic printing according to claim 2, wherein the reactive silicone foam stabilizer in the polyurethane foam has an SiO % in a range of 10 to 25%.

10. A cushioning material for flexographic printing according to claim 3, wherein the reactive silicone foam stabilizer in the polyurethane foam has an SiO % in a range of 10 to 25%.

11. A cushioning material for flexographic printing according to claim 2, wherein the cushioning material for flexographic printing has a total light transmission 55% or more.

12. A cushioning material for flexographic printing according to claim 3, wherein the cushioning material for flexographic printing has a total light transmission 55% or more.

13. A cushioning material for flexographic printing according to claim 4, wherein the cushioning material for flexographic printing has a total light transmission 55% or more.

14. A cushioning material for flexographic printing according to claim 5, wherein the cushioning material for flexographic printing has a total light transmission 55% or more.

15. A cushioning material for flexographic printing according to claim 6, wherein the cushioning material for flexographic printing has a total light transmission 55% or more.
